(19) United States
(12) Patent Application Publication
(10) Pub. No.: US 2009/0191453 A1
(43) Pub. Date: Jul. 30, 2009

(54) CAR POWER SOURCE APPARATUS

(76) Inventors: Kazuhiro FUJII, Hyogo (JP); Atsushi Fujita, Hyogo (JP)

Correspondence Address: WENDEROTH, LIND & PONACK, L.L.P., 1030 15th Street, N.W.,, Suite 400 East, Washington, DC, 20005-1503, US

(21) Appl. No.: 12/360,420

(22) Filed: Jan. 27, 2009

(30) Foreign Application Priority Data
Jan. 29, 2008 (JP) 2008-17904

(51) Int. Cl. H01M 6/42

(52) U.S. Cl. 429/120

(57) ABSTRACT

The car power source apparatus is provided with a battery block 10 housing a plurality of batteries 11 in a battery case 12, and an electronic component block 20 with an electronic component case 22 housing electronic components 21, which connect with the batteries 11 in the battery block 10. The electronic component case 22 of the electronic component block 20 houses relays 31 that cut-off battery block 10 battery current. The relays 31 are disposed in a thermally connected fashion with the electronic component case 22 via flexible thermally conducting sheet 30. The section of the electronic component case 22 thermally connected with the relays 31 is a metal case, and heat generated by the relays 31 is transferred via the flexible thermally conducting sheet 30 to the metal case where it is radiated to the outside.

### BACKGROUND OF THE INVENTION

1. Field of the Invention

The present invention relates to a power source apparatus on-board a car that supplies power to the motor that drives the car.

2. Description of the Related Art

The on-board power source apparatus that drives the motor to run a car is provided with a battery block housing a plurality of batteries in a battery case, and an electronic component block that controls battery charging and discharging. The electronic component block controls battery charging and discharging, and to increase safety, electronic components are housed in an electronic component case. The electronic component block houses relays, which are connected in series with the batteries, inside the electronic component case. When the car ignition switch is OFF, these relays are OFF and battery output is cut-off. When the ignition switch is turned ON and the car is driven, the relays are switched ON. Since the relays control high charging and discharging currents between the batteries and the car-side load, a high-capacity type of relay that can cut-off high currents is used. In these relays, high currents are also passed through magnetic coils to keep contacts closed in the ON state. For example, power consumption by a magnetic coil can become relatively large at approximately 6 W. In addition, current through relay contacts is large, and heat generation results from contact resistance Joule-heating. Consequently, temperature rises for relays in the ON state due to heat generation from magnetic coil power consumption as well as Joule-heating from high contact current. A relay, which has risen in temperature, has a detrimental heating effect on surrounding electronic components and printed circuit boards. In particular, high temperature causes detection errors for current sensors housed in the electronic component block.

To cool the electronic component block, an apparatus that force ventilates the inside the electronic component case with cooling air has been developed (See Japanese Patent Laid-Open Publication No. H11-180168A (1999)).

In the power source apparatus cited in JP H11-180168A (1999), electronic components are cooled by cooling air that cools the batteries. In this system, both the batteries and the electronic components are cooled by a common cooling fan. In this type of power source apparatus, cooling air, which has passed through the battery chamber housing the batteries, ventilates the electronic component chamber to cool the electronic components. Therefore, cooling air that has been warmed by the batteries and raised to a higher temperature cools the electronic components. Consequently, the temperature of the cooling air for the electronic components becomes high and efficient cooling of the electronic components is difficult. Further, since cooling air ventilates the electronic component case housing various electronic components, specific components that generate large quantities of heat cannot be efficiently cooled. Not all electronic components disposed in the electronic component case are heat-generating components. In addition, the temperature and amount of heat produced by the heat-generating components is different, with certain components reaching high temperatures and other components showing little temperature rise. A ventilating configuration that discharges battery chamber cooling air into the electronic component chamber cannot efficiently cool high temperature heat-generating components in a concentrated fashion with the cooling air introduced to the electronic component chamber. Further, in a ventilating configuration that discharges battery chamber cooling air into the electronic component case, resistance to the flow of cooling air through the electronic component case affects ventilation of the battery chamber. Therefore, this system also has the drawback that efficient battery cooling becomes difficult because of electronic component cooling.

The present invention was developed to resolve the drawbacks described above. Thus, it is a primary object of the present invention to provide a car power source apparatus that can very efficiently cool relays, which are large heat-generating components, and can efficiently cool those relays while reducing the effects of relay cooling on battery cooling.

### SUMMARY OF THE INVENTION

The car power source apparatus of the present invention is provided with the following structure to realize the object described above. The car power source apparatus is provided with a battery block 10 that houses a plurality of batteries 11 in a battery case 12, and an electronic component block 20 that has an electronic component case 22 housing electronic components 21, which connect to batteries 11 in the battery block 10. The electronic component case 22 of the electronic component block 20 contains relays 31, which cut-off battery current from the battery block 10, and those relays 31 are disposed in a thermally connected manner with the electronic component case 22 via flexible thermally conducting sheet 30. Further, regions of the electronic component case 22 thermally joined with the relays 31 are metal, heat generated by the relays 31 is transferred to the metal case via the flexible thermally conducting sheet 30, and that heat is radiated to the outside.

This power source apparatus has the characteristic that relays, which are electronic components that generate large quantities of heat, can be cooled extremely efficiently. In particular, it has the characteristic that relays can be efficiently cooled without affecting battery cooling. This is because the heat-generating relays are thermally joined via flexible thermally conducting sheet with the electronic component case of the car power source apparatus, regions of the electronic component case thermally joined with the relays are metal, heat generated by the relays is transferred to the metal case via the flexible thermally conducting sheet, and the transferred heat is radiated to the outside. In addition, this system realizes the characteristic that relays are efficiently cooled while preventing noise due to vibration, which is extremely important for a car power source apparatus. This is because the relays are thermally joined with the electronic component case via flexible thermally conducting sheet. Finally, as a result of the novel structure of the present invention, it also realizes the characteristic that even with the passage of time and distortion of elements such as the electronic component case, the relays can be cooled without generating noise.

The above and further objects of the present invention as well as the features thereof will become more apparent from the following detailed description to be made in conjunction with the accompanying drawings.

### BRIEF DESCRIPTION OF THE DRAWINGS

FIG. 1 is an abbreviated plan view of the car power source apparatus for one embodiment of the present invention;

FIG. 2 is an oblique view of the car power source apparatus for one embodiment of the present invention;

FIG. 3 is an oblique view of the electronic component block of the car power source apparatus shown in FIG. 2;

FIG. 4 is a plan view of the electronic component block shown in FIG. 3.

FIG. 5 is an exploded oblique view of the electronic component block shown in FIG. 3;

FIG. 6 is a horizontal cross-section view of the electronic component block shown in FIG. 3;

FIG. 7 is a cross-section view through the line A-A of the electronic component block shown in FIG. 6;

FIG. 8 is an abbreviated cross-section view of the electronic component block shown in FIG. 3;

FIG. 9 is an exploded oblique view of the inner case;

FIG. 10 is an exploded oblique view of the inner case shown in FIG. 9; and

FIG. 11 is an exploded oblique view of the inner case shown in FIG. 10 viewed from below.

### DETAILED DESCRIPTION OF THE EMBODIMENT(S)

In an embodiment of the car power source apparatus of the present invention, the electronic component case 22 is a metal case made of aluminum.

In this car power source apparatus, the electronic component case 22 is a metal case made of aluminum. Because of the superior heat conducting properties of aluminum, this power source apparatus has overall light weight and can efficiently cool the relays.

In another form of embodiment of the car power source apparatus, the relays 31 are held inside the electronic component case 22 via an inner case 23. The electronic component case 22 is provided with a lower case 22A, which is thermally joined with the relays 31, and an upper case 22B, which connects with the lower case 22A. The relays 31 are connected with the upper case 22B via the inner case 23.

In this car power source apparatus, the relays are held inside the electronic component case via the inner case; the electronic component case is provided with a lower case thermally joined with the relays and an upper case connecting with the lower case; and the relays are connected with the upper case via the inner case. In this power source apparatus, since the relays are not fixed to lower case, the upper case can be separated from the lower case allowing easy access and maintenance of the relays. At the same time, the relays are in close contact with the electronic component case via flexible thermally conducting sheet to allow efficient cooling.

In another form of embodiment of the car power source apparatus, the upper case 22B has a main case 24 with an open region 26, and a closing plate 25 that closes off the open region 26 of the main case 24. The inner case 23 is connected to the closing plate 25, and the inner case 23 connects to the main case 24 of the upper case 22B via the closing plate 25.

In this car power source apparatus, the upper case has a main case with an open region, and a closing plate that closes off the open region of the main case; the inner case is connected to the closing plate, and the inner case connects to the main case of the upper case via the closing plate. Therefore, the relays can be attached to the electronic component case via the inner case, which is connected to the closing plate. This allows easy maintenance.

In another form of embodiment of the car power source apparatus, the closing plate 25 connects with the main case 24 in a watertight configuration.

In this car power source apparatus, since the closing plate is connected to the main case in a watertight fashion, the electronic component case can have a watertight configuration with a simple structure.

In another form of embodiment of the car power source apparatus, the electronic component block 20 is disposed adjacent to the battery block 10. Further, the electronic component block 20 houses circuit boards 35 in the electronic component case 22, and the relays 31 are disposed between the circuit boards 35 and the battery block 10.

In this car power source apparatus, the electronic component block is disposed adjacent to the battery block; the electronic component block houses circuit boards in the electronic component case; and the relays are disposed between the circuit boards and the battery block. Therefore, this power source apparatus has the characteristic that the relay noise level can be reduced. This is because the relays are between the circuit boards and the battery block, and the circuit boards and battery block shield the relay noise.

In another form of embodiment of the car power source apparatus, thermally conducting plates made of sheet metal are mounted on relay 31 surfaces, and the surfaces of those thermally conducting plates are disposed in thermal contact with the electronic component case 22 via flexible thermally conducting sheet 30.

In this car power source apparatus, since thermally conducting plates made of sheet metal are mounted on relay surfaces, and the surfaces of those thermally conducting plates are disposed in thermal contact with the electronic component case via flexible thermally conducting sheet, the surfaces of the relays can be efficiently and uniformly cooled via the sheet metal thermally conducting plates. This is because thermally conducting plates, which are made of metal with superior heat conducting properties, can make thermal contact with relay surfaces over a wide area to enable cooling.

In another form of embodiment of the car power source apparatus, the electronic component block 20 houses a current sensor 34 that detects battery 11 current, and a pre-charge resistor 32 that pre-charges a capacitor connected in parallel with the load on the car-side.

In this car power source apparatus, since the electronic component block houses a current sensor that detects battery current, and a pre-charge resistor that pre-charges a capacitor connected in parallel with the load on the car-side, pre-charge resistor heat, in addition to relay heat, can be effectively radiated away by the electronic component case.

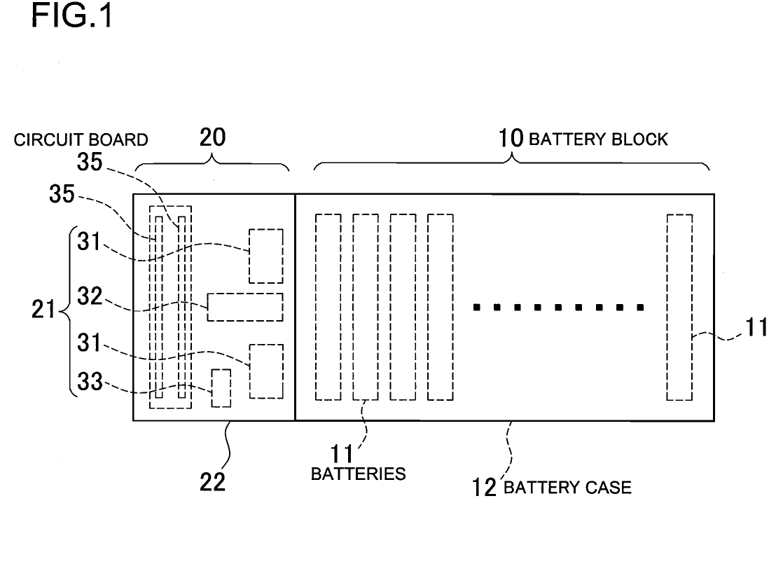

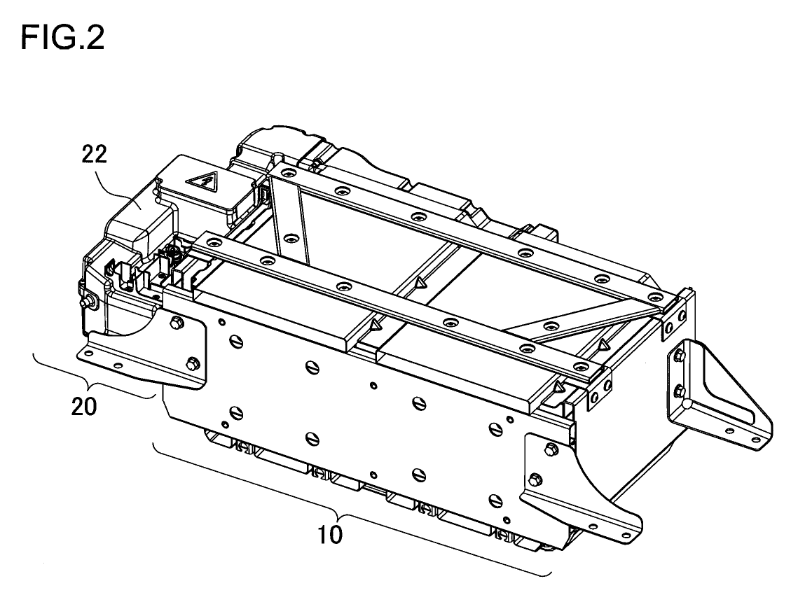

The car power source apparatus shown in the abbreviated plan view of FIG. 1 and the oblique view of FIG. 2 is provided with a battery block 10 having a plurality of batteries 11 housed in a battery case 12, and an electronic component block 20 having electronic components 21 housed in an electronic component case 22.

The power source apparatus is installed on-board a car with the battery block 10 joined to the electronic component block 20, and an external cover (not illustrated) connected. Ducts (not illustrated) are established between the external cover and the battery block 10 to cool the batteries 11. Batteries 11 are cooled by ventilation from the ducts that is introduced inside the battery block 10.

The battery block 10 has a plurality of batteries 11 held in fixed positions by a structure such as a holder case (not illustrated) and housed inside a battery case 12. In addition, the battery block 10 has cooling airflow inlets and outlets opened in the battery case 12, and batteries 11 are cooled by forced ventilation from the ducts established between the external cover and the battery case 12. Batteries 11 in the battery block 10 are rechargeable batteries such as nickel hydride batteries or lithium ion rechargeable batteries. Batteries 11 housed in the battery case 12 are connected in series to increase output voltage. However, the plurality of batteries can also be connected in series and parallel to increase output voltage and output current.

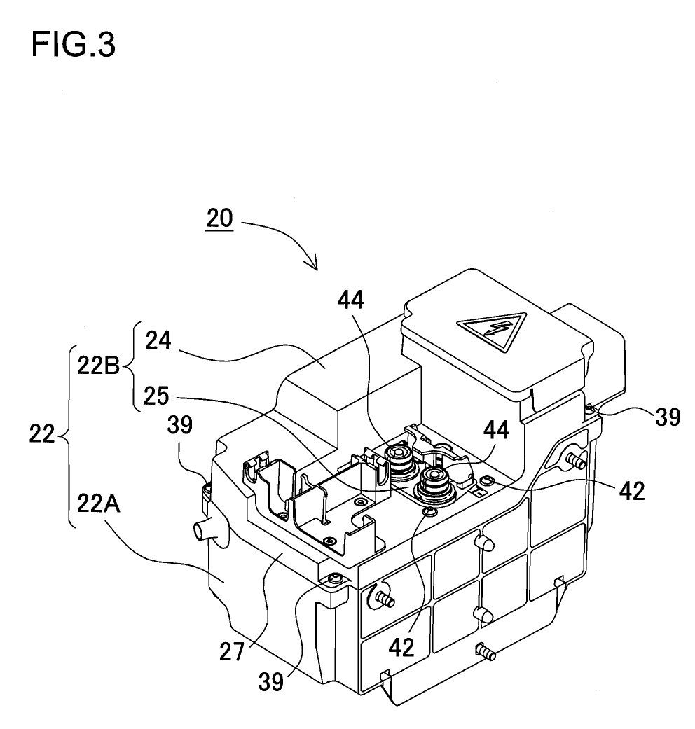

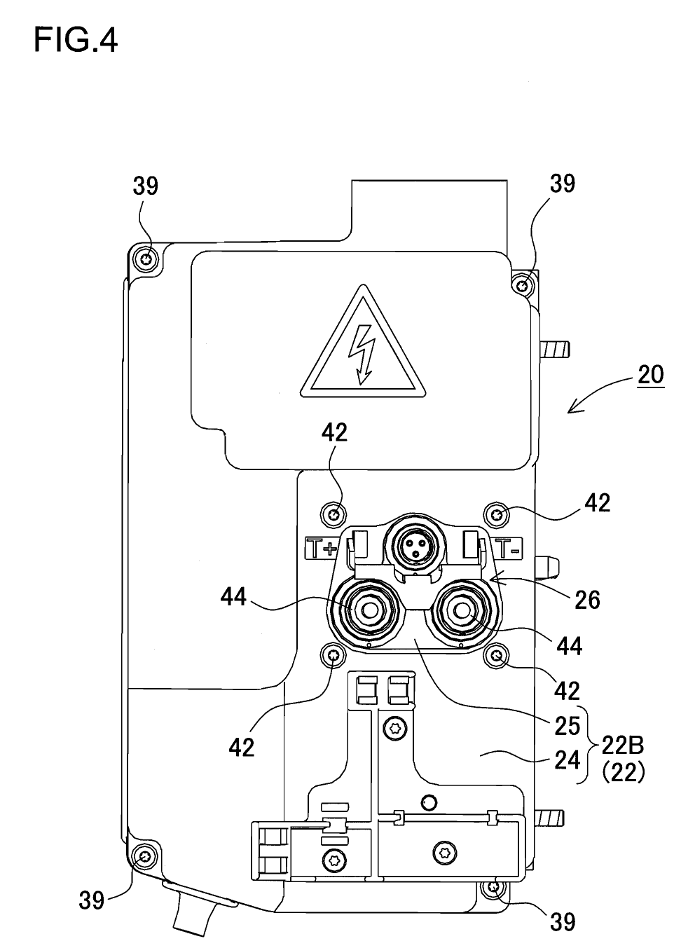

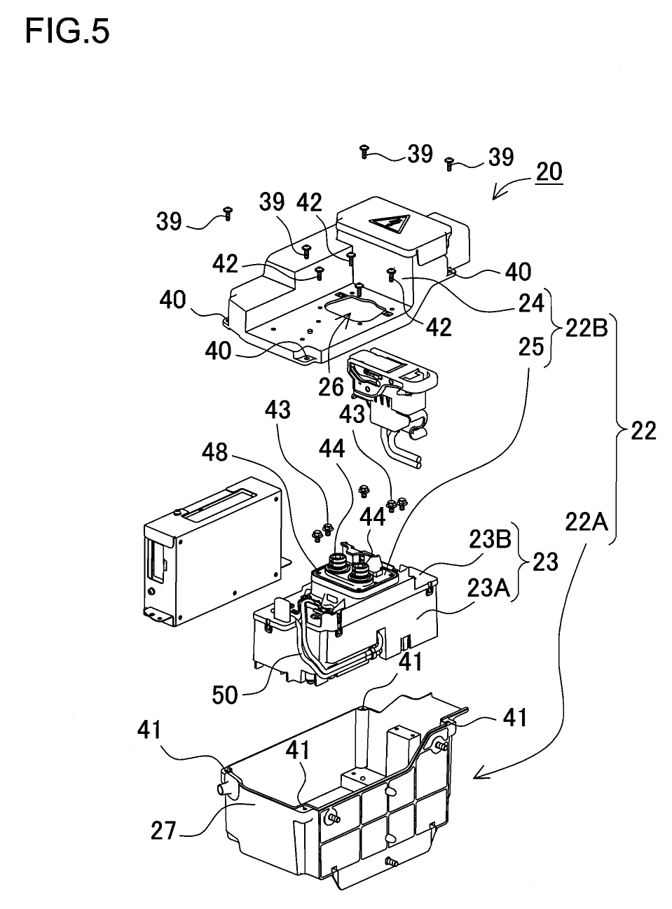

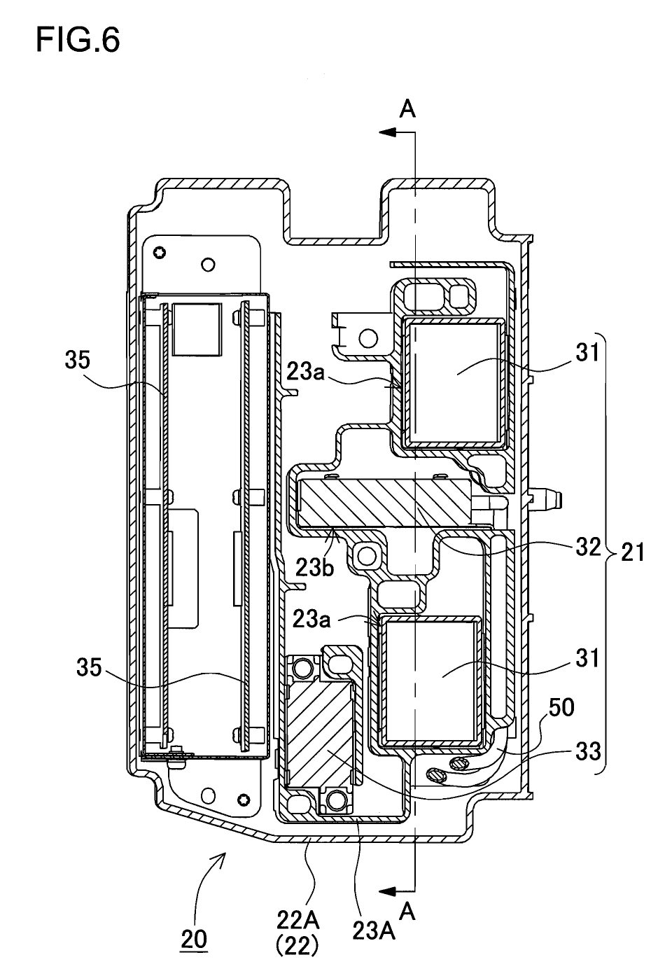

The electronic component block 20 houses heat-generating components such as the relays 31 and the pre-charge resistor 32 in the electronic component case 22. The electronic component block 20 shown in FIGS. 3-11 includes the electronic component case 22, the pair of relays 31 that cut-off battery block 10 current, the pre-charge resistor 32 that pre-charges the capacitor (not illustrated) connected with the car-side load prior to switching the relays 31 ON, the inner case 23 that retains the pre-charge resistor 32 and relays 31 in fixed positions, the current sensor 34 that detects battery 11 current, and the printed circuit boards 35 that determines battery conditions. In particular, the power source apparatus shown in FIG. 1 has the electronic component block 10 disposed next to the battery block 10, and the relays 31 housed inside the electronic component case 22 of the electronic component block 20 are disposed between the printed circuit boards 35 and the battery block 10. This configuration has the characteristic that relay 31 noise levels can be reduced. This is because the printed circuit boards 35 and the battery block 10 can constrain relay 31 noise. However, the layout of electronic components housed in the electronic component block is not restricted to the layout shown in the figures.

The relays 31 are connected to the positive and negative output-sides of the batteries 11 in the battery block 10. Relays 31 are switched ON when the ignition switch, which is the car's main switch, is turned ON to drive the car, and relays 31 are switched OFF when the ignition switch is turned OFF or an abnormal condition develops. Control circuitry (not illustrated) to switch the positive and negative relays 31 ON and OFF is mounted on the printed circuit boards 35. In addition, pre-charge circuitry including the pre-charge resistor 32 and a pre-charge relay 33, which pre-charge the car-side capacitor prior to switching the relays 31 ON, is also housed in the electronic component case 22. The pre-charge relay 33 is controlled ON and OFF by control circuitry also mounted on the printed circuit boards 35. When the ignition switch is turned ON, control circuits maintain the positive-side relay 31 in the OFF state and switch the negative-side relay 31 and the pre-charge relay 33 ON to pre-charge the car-side capacitor. Subsequently, the negative-side relay 31 is maintained in the ON state and the positive-side relay 31 is switched ON to connect the batteries 11 with the car-side load. Finally, the pre-charge relay 33 is switched OFF.

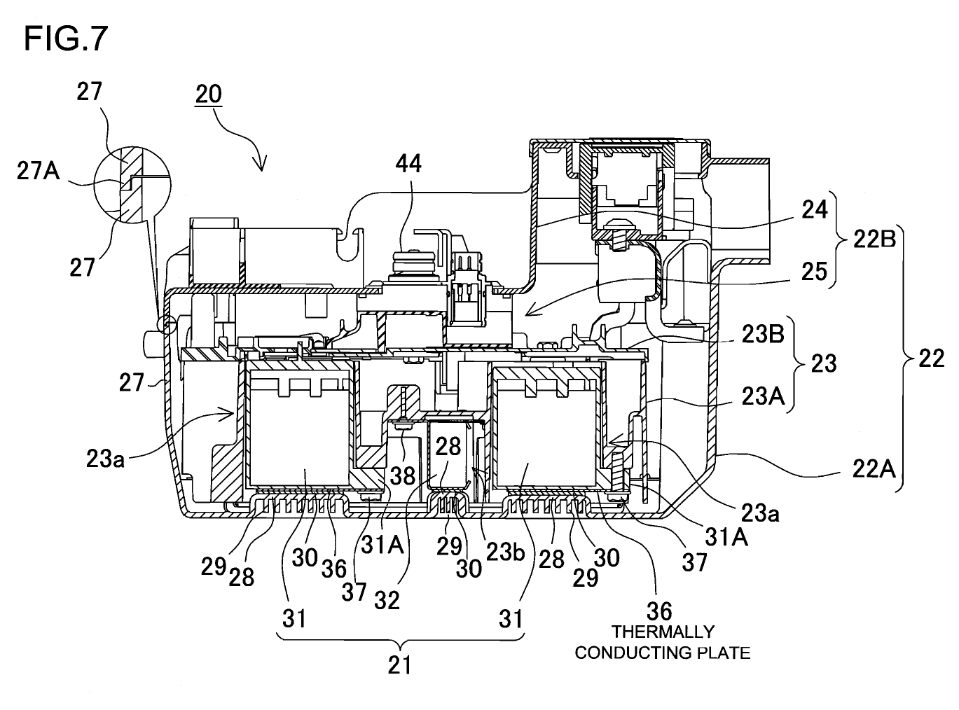

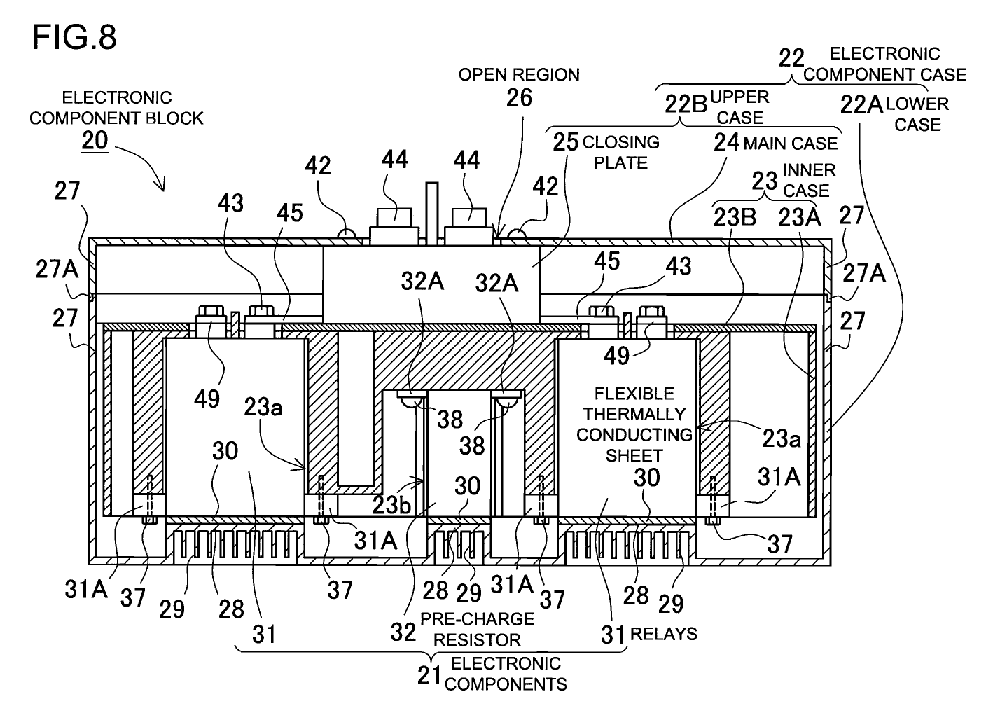

In the ON state, current flows through the magnetic coils of the relays 31 generating heat. To effectively radiate and dissipate relay 31 heat, relays 31 are in close contact and thermally connected to the electronic component case 22 via flexible thermally conducting sheet 30. In the electronic component block 20 shown in FIGS. 7 and 8, the pre-charge resistor 32, which is a heat-generating component, is also in close contact and thermally connected to the inner surface of the electronic component case 22 via flexible thermally conducting sheet 30. In an electronic component block 20 with the relays 31 and pre-charge resistor 30 thermally connected to the electronic component case 22 via flexible thermally conducting sheet 30, heat generated by the relays 31 and pre-charge resistor 32 can be efficiently radiated away by the electronic component case 22.

Flexible thermally conducting sheet 30 is sandwiched between the relays 31 and the pre-charge resistor 32 and the electronic component case 22. Flexible thermally conducting sheet 30 can flexibly deform allowing its thickness to change, and it has superior thermal conduction. For example, silicone resin sheet can be used as the flexible thermally conducting sheet 30. Sheet that is, for example, thicker than 0.3 mm, preferably thicker than 0.4 mm, and still more preferably thicker than 0.5 mm can be used as the flexible thermally conducting sheet 30. If the flexible thermally conducting sheet is too thin, it will not be able to absorb dimensional inaccuracies and distortion over time in parts such as the electronic component case, and it will not be able to keep the relays in close contact with the surface of the electronic component case. However, if the flexible thermally conducting sheet is too thick, heat conduction from the relays to the electronic component case will degrade. Consequently, flexible thermally conducting sheet 30 thickness is made, for example, thinner than 3 mm, and preferably thinner than 2 mm. For the case where silicone resin sheet with, for example, a thickness of approximately 1 mm is used as the flexible thermally conducting sheet 30, relays 31 can be disposed in a thermally connected fashion with the inner surface of the electronic component case 22 while absorbing electronic component case 22 dimensional inaccuracies and distortion over time.

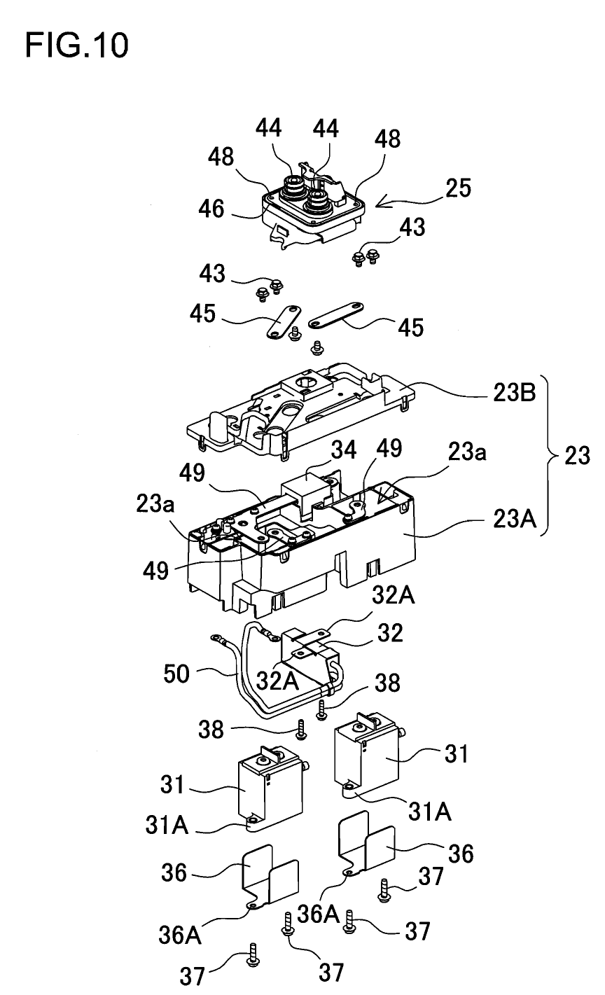

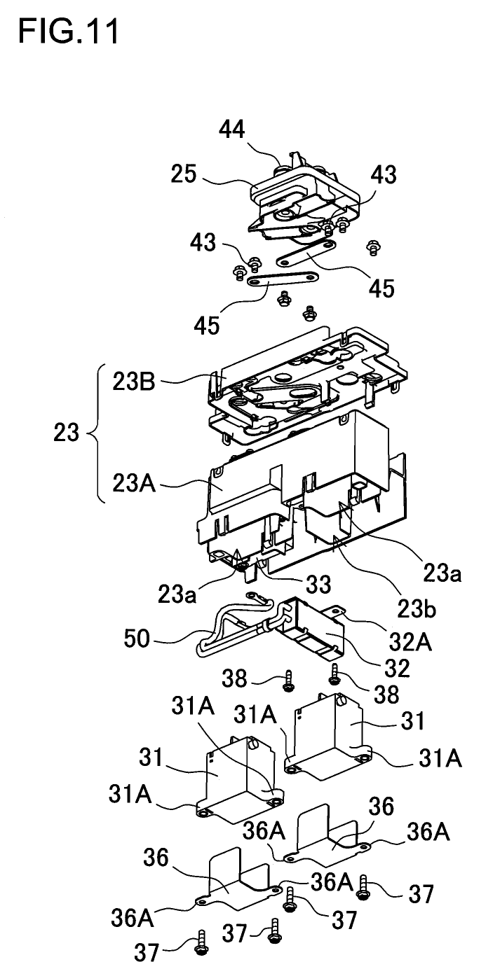

Although relays 31 can be put directly in contact and thermally connected to the electronic component case 2 via flexible thermally conducting sheet 30, thermally conducting plates 36 made of sheet metal can be fixed in close attachment to relay 31 surfaces, as shown in FIGS. 10 and 11. These relays 31 are in close contact with flexible thermally conducting sheet 30 via the thermally conducting plates 36 on their surfaces, and they are thermally connected with the electronic component case 22 via the thermally conducting plates 36 and flexible thermally conducting sheet 30. The thermally conducting plates 36 of the figures are shaped to fit tightly with the bottom and side surfaces of the relays 31. In particular, the thermally conducting plates 36 of the figures are sheet metal pieces formed in u-shapes to mate tightly with the bottom and both side surfaces of the relays 31. A thermally conducting plate 36 tightly attaches to both sides of a relay 31 by virtue of its inherent flexibility. In addition, a thermally conducting plate 36 is fixed to a relay 31 with set screws 37 to tightly attach it to the bottom surface of the relay 31. To enable attachment of thermally conducting plates 36 to relays 31, a projecting piece 36A is established on both sides of the bottom surface of each thermally conducting plate 36. The projecting pieces 36A have through-holes and corresponding projecting pieces 31A on the relays 31 also have through-holes. Set screws 37 are inserted through both through-holes to attach the thermally conducting plates 36 to the relays 31.

Although not illustrated, a thermally conducting plate can also be attached to the pre-charge resistor, and the thermally conducting plate can be put in close contact with flexible thermally conducting sheet to enable efficient thermal radiation. A resistor such as a rectangular cylindrical block resistor can be used as the pre-charge resistor 32. The thermally conducting plate can be tightly attached in a thermally connected fashion to the bottom and both side surfaces of the block pre-charge resistor 32 in the same manner as the relays 31 of FIGS. 10 and 11.

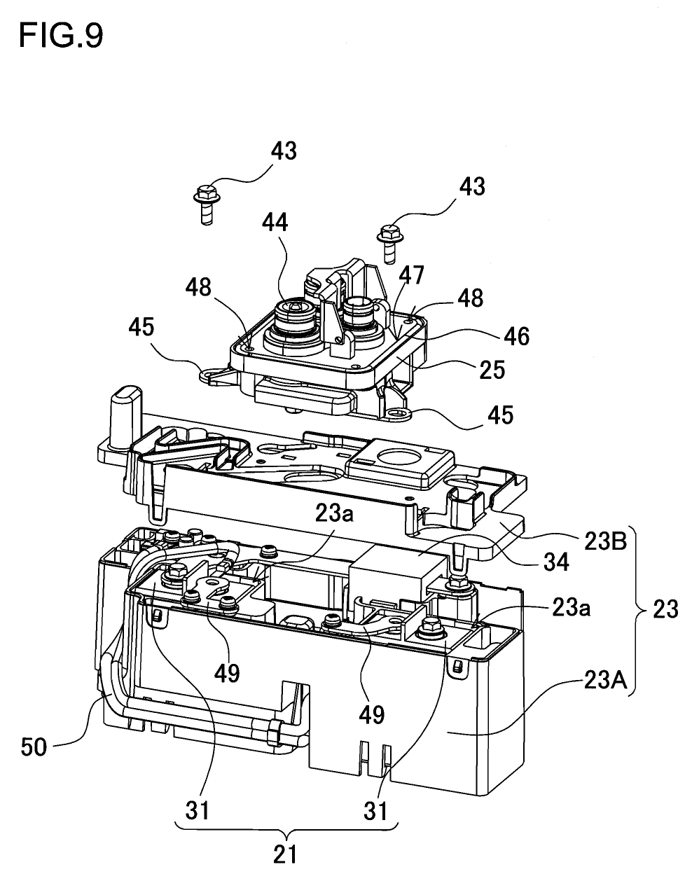

The electronic component block 20 shown in FIGS. 7 and 8 has components such as the relays 31 and the pre-charge resistor 32 contained in the electronic component case 22 via the inner case 23. FIGS. 9-11 show exploded oblique views of the inner case 23. This inner case 23 is provided with a first inner case 23A that holds the relays 31 and pre-charge resistor 32, and a second inner case 23B that attaches to the upper surface of the first inner case 23A. The second inner case 23B connects with the closing plate 25 that closes off the open region 26 of the upper case 22B of the electronic component case 22.

The first inner case 23A is provided with relay attachment sections 23a to hold the relays 31 in fixed positions, and a pre-charge resistor attachment section 23b to hold the pre-charge resistor 32 in a fixed position. The lower ends of the relay attachment sections 23a and the pre-charge resistor attachment section 23b are open and the exposed relays 31 and pre-charge resistor 32 at those open regions are thermally joined with the electronic component case 22. Relays 31 are inserted into the relay attachment sections 23a and mounted on the first inner case 23A via set screws 37 through the projecting pieces 31A on the relays 31. The pre-charge resistor 32 is inserted into the pre-charge resistor attachment section 23b and mounted on the first inner case 23A via set screws 38 through pre-charge resistor 32 projecting pieces 32A. With the relays 31 and the pre-charge resistor 32 attached, the second inner case 23B is mounted on top of the first inner case 23A.

The outline of the second inner case 23B is the same as the first inner case 23A allowing it to cover the upper surface of the first inner case 23A. The perimeter regions of the second inner case 23B are joined to the first inner case 23A.

The electronic component case 22 is provided with a lower case 22A that is thermally connected with the relays 31 and the pre-charge resistor 32, and an upper case 22B that joins with the top of the lower case 22A to close off its open region. The upper case 22B and the lower case 22A have perimeter walls 27 connected to the rims of the open regions, and these perimeter walls 27 are joined to close off the upper open region of the lower case 22A with the upper case 22B. As shown in the enlarged cross-section inset of FIG. 7, projections 27A are provided along upper perimeter walls 27, and lower perimeter walls 27 are formed with a step shape to mate with those projections 27A. In the electronic component case 22 of FIG. 7, projections 27A are provided along the outside edge of perimeter walls 27 of the upper case 22B. Perimeter walls 27 of the lower case 22A are formed with a step shape to fit with the projections 27A. Projections 27A are fit into step shapes to join lower case 22A and upper case 22B perimeter walls 27 in a water resistant configuration.

To join the upper case 22B and the lower case 22A, connecting holes 40 for set screw 39 insertion are provided in the upper case 22B, and screw holes 41 for anchoring the set screws 39 are provided in the lower case 22A. In the electronic component case 22 of the figures, connecting holes 40 are established through the four corner regions of the upper case 22B. Set screws 39 are passed through the upper case 22B connecting holes 40 and threaded into the lower case 22A screw holes 41 to join the upper case 22B to the lower case 22A. The lower case 22A, which is in close contact and thermally connected with the relays 31, is made of aluminum. An aluminum lower case 22A is manufactured by molding or die-casting. Further, the upper case 22B can also be made of aluminum to increase relay 31 heat-sink area and allow efficient radiation. However, the electronic component case can also have only the case section thermally connected with the relays as a metal case.

In the lower case 22A of FIGS. 7 and 8, thermal connection regions 28 for the relays 31 and the pre-charge resistor 32 are recessed regions, and heat-sink radiation cooling fins 29 are provided on the surface of those thermal connection regions 28. Radiation cooling fins 29 have large surface area and can efficiently cool the thermal connection regions 28, that is they can efficiently cool the relays 31 and pre-charge resistor 32. In particular, by establishing cooling fins 29 in recessed regions, the relays 31 and pre-charge resistor 32 can be more efficiently cooled without having cooling fins 29 sticking out from the surface of the case.

The upper case 22B is provided with a main case 24 having an open region 26, and a closing plate 25 that closes off the open region 26 of the main case 24. The closing plate 25 is attached to the main case 24 via set screws 42 to seal off the open region 26 of the main case 24 in a water-tight fashion. In addition, the closing plate 25 is mounted on the inner case 23 with connecting bolts 43. The closing plate 25 of the figures is provided with positive and negative output terminals 44 on its upper surface, and positive and negative output lead plates 45, which are connected to those output terminals 44, are attached on the bottom side. One end of the output lead plates 45 connects with the output terminals 44, and the other ends connect with relay 31 terminals via the connecting bolts 43. Specifically, the closing plate 25 is connected via output lead plates 45 to the relays 31, which are attached to the inner case 23. This in-turn attaches the closing plate 25 to the upper surface of the inner case 23. However, the closing plate can also be attached to the upper surface of the inner case via fasteners such as set screws.

In this electronic component block 20, the inner case 23 is connected to the main case 24 of the upper case 22B via the closing plate 25. The relays 31 and pre-charge resistor 32 are connected to the inner case 23, and the inner case 32 is in-turn connected to the main case 24 of the upper case 22B via the closing plate 25. In this electronic component block 20, since the upper case 22B can be separated from the lower case 22A to remove the relays 31 and pre-charge resistor 32 from the electronic component case 22, relay 31 and pre-charge resistor 32 maintenance is simplified. This is because the relays 31 and pre-charge resistor 32 are not directly fixed to the lower case 22A.

The closing plate 25 is attached to the upper surface of the second inner case 23B via the output lead plates 45. The closing plate 25 of the figures holds the output terminals 44. The output terminals 44 pass through the closing plate 25, and are attached to the closing plate 25 in a water-tight configuration. The closing plate 25 is formed from insulating material such as plastic. The positive and negative output terminals 44 are mounted in an insulating fashion. An O-ring 46 is disposed along the perimeter of the upper surface of the closing plate 25 to make a water-tight seal and close off the open region 26 of the main case 24, which is the upper case 22B. The O-ring 46 is seated in an O-ring groove 47 established around the perimeter of the upper surface of the closing plate 25. Inside the O-ring 46, screw holes 48 are provided to anchor set screws that join the closing plate 25 to the main case 24. The outline of the closing plate 25 is larger than the main case 24 open region 26, and the closing plate 25 mates closely with the inner walls of the open region 26 to close off the open region 26 in a water-tight fashion.

The power source apparatus described above is assembled in the following manner.
(1) Electronic components 21 including the relays 31 and pre-charge resistor 32 are mounted in the inner case 23. As shown in FIGS. 10 and 11, these electronic components 21 are inserted through the open bottom region of the first inner case 23A and are attached in fixed positions inside the first inner case 23A. Relays 31 are inserted into the relay attachment sections 23a of the first inner case 23A and attached via set screws 37. The pre-charge resistor 32 is inserted into the pre-charge resistor attachment section 23b of the first inner case 23A and attached via set screws 38. In addition, the pre-charge relay 33 is also attached in a fixed position inside the first inner case 23A.
(2) As shown in FIG. 9, electronic components 21 mounted in fixed positions in the first inner case 23A are wired for electrical connection at the upper surface of the first inner case 23A. These electronic components 21 are connected via connection lead plates 49 and wire leads 50. In addition, the current sensor 34 is attached and wired on the upper surface of the first inner case 23A.
(3) The second inner case 23B is joined to the upper surface of the first inner case 23A.
(4) The closing plate 25 of the upper case 22B is attached to the top of the second inner case 23B. As shown in FIGS. 10 and 11, output lead plates 45 are connected to the bottom of the closing plate 25, and one end of those output lead plates 45 connects with the output terminals 44. The other ends of the output lead plates 45 connect to relay 31 terminals via connecting bolts 43 thereby attaching the closing plate 25 to the inner case 23.
(5) The inner case 23 is inserted into the lower case 22A. Here, flexible thermally conducting sheet 30 is disposed between the lower case 22A thermal connection regions 28 and the bottom surfaces of the relays 31 and the pre-charge resistor 32, which are exposed from the bottom of the inner case 23. This disposes the relays 31 and the pre-charge resistor 32 in thermal connection with the electronic component case 22 via the flexible thermally conducting sheet 30. The flexible thermally conducting sheet 30 can be adhered to the bottom of the relays 31 and the pre-charge resistor 32, or adhered to the lower case 22A thermal connection regions 28 to retain it in fixed positions.
(6) The main case 24 is disposed on top of the closing plate 25 to attach the main case 24 to the lower case 22A and the closing plate 25. The rim of the perimeter walls 27 around the outside of the main case 24 is mated with the rim of the perimeter walls 27 of the lower case 22A, and the open region 26 is positioned to be closed off by the closing plate 25. The main case 24 is fixed to the closing plate 25 via set screws 42 around the outside of the open region 26. In addition, the main case 24 is fixed to the lower case 22A by passing set screws 39 through connecting holes 40 established at the four corners and anchoring them in screw holes 41 in the lower case 22A.
The electronic component block 20 is assembled by the preceding process flow.

(7) The electronic component block 20 is disposed next to the battery block 10, and the electronic component block 20 is joined to the battery block 10 via fasteners or the like. In addition, positive and negative output from the battery block 10 is connected to electronic component block 20 input terminals (not illustrated) to complete assembly of the power source apparatus.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2008-17,904 filed in Japan on Jan. 29, 2008, the content of which is incorporated herein by reference.

What is claimed is:

1. A car power source apparatus comprising:
a plurality of batteries;
a battery block made up of a battery case housing the plurality of batteries;
electronic components connected to the batteries contained in the battery block; and
an electronic component block made Lip of an electronic component case housing the electronic components,
wherein the electronic component case of the electronic component block houses relays, which cut-off battery block battery current,
the relays are disposed in a thermally connected fashion with the electronic component case via flexible thermally conducting sheet, the section of the electronic component case thermally connected with the relays is a metal case, and
the power source apparatus is configured to transfer heat generated by the relays via the flexible thermally conducting sheet to the metal case for radiation to the outside.

2. The car power source apparatus as cited in claim 1 wherein the electronic component case is a metal case made of aluminum.

3. The car power source apparatus as cited in claim 1 wherein the electronic component block is provided with an inner case housing the relays.

4. The car power source apparatus as cited in claim 1 wherein the electronic component block is provided with a pre-charge resistor that pre-charges a capacitor connected to the car-side load.

5. The car power source apparatus as cited in claim 1 wherein the electronic component block is provided with an inner case that holds the relays in fixed positions.

6. The car power source apparatus as cited in claim 4 wherein the electronic component block is provided with an inner case that holds the relays in fixed positions, and that inner case holds the pre-charge resistor in a fixed position.

7. The car power source apparatus as cited in claim 1 wherein the electronic component block is provided with printed circuit boards that determine the state of the batteries.

8. The car power source apparatus as cited in claim 7 wherein the electronic component block is disposed adjacent to the battery block, the electronic component block houses the printed circuit boards in the electronic component case, and the relays are disposed between the printed circuit boards and the battery block.

9. The car power source apparatus as cited in claim 4 wherein the pre-charge resistor is thermally connected with the electronic component case via flexible thermally conducting sheet.

10. The car power source apparatus as cited in claim 1 wherein the flexible thermally conducting sheet is sandwiched between the relays and the electronic component case, and that flexible thermally conducting sheet is sheet that can flexibly deform and change thickness.

11. The car power source apparatus as cited in claim 10 wherein the flexible thermally conducting sheet is silicone resin sheet.

12. The car power source apparatus as cited in claim 1 wherein the flexible thermally conducting sheet is thicker than 0.3 mm.

13. The car power source apparatus as cited in claim 1 wherein the flexible thermally conducting sheet is thinner than 3 mm.

14. The car power source apparatus as cited in claim 1 wherein the relays are thermally connected to the electronic component case directly via flexible thermally conducting sheet.

15. The car power source apparatus as cited in claim 1 wherein the electronic component block is provided with thermally conducting plates made of sheet metal attached to the surfaces of the relays, and the surfaces of those thermally conducting plates are disposed in thermal connection with the electronic component case via flexible thermally conducting sheet.

16. The car power source apparatus as cited in claim 15 wherein the thermally conducting plates are shaped to tightly attach with bottom and side surfaces of the relays.

17. The car power source apparatus as cited in claim 16 wherein the thermally conducting plates are sheet metal pieces bent in u-shapes to tightly attach to the bottom and both side surfaces of the relays, the thermally conducting plates tightly attach to both sides of the relays by virtue of their inherent elasticity, and they are fastened to the relays for tight attachment to the bottom surface.

18. The car power source apparatus as cited in claim 5 wherein the relays are housed in the electronic component case via the inner case; the electronic component case is provided with a lower case, which thermally connects with the relays, and an upper case that connects with the lower case; and the relays connect to the upper case via the inner case.

19. The car power source apparatus as cited in claim 18 wherein the upper case has a main case having an open region, and a closing plate that closes off the main case open region; the inner case is connected to this closing plate, and the inner case is connected to the main case of the upper case via the closing plate.

20. The car power source apparatus as cited in claim 4 wherein the closing plate is connected to the main case in a water-tight configuration.

21. The car power source apparatus as cited in claim 1 wherein the electronic component block houses a current sensor that detects battery current.
